(19) United States
(12) Patent Application Publication
(10) Pub. No.: US 2021/0237918 A1
(43) Pub. Date: Aug. 5, 2021

(54) FOOD PACKAGE AND METHOD OF MANUFACTURING SAME

(71) Applicant: Richard M. Krafsur, Grand Blanc, MI (US)

(72) Inventor: Richard M. Krafsur, Grand Blanc, MI (US)

(21) Appl. No.: 17/218,767

(22) Filed: Mar. 31, 2021

Related U.S. Application Data
(63) Continuation-in-part of application No. 16/778,411, filed on Jan. 31, 2020.

(51) Int. Cl. B65B 25/00; B32B 27/36; B32B 7/12; B32B 27/08; B65D 81/24; B65D 65/40; A23G 3/54; A23L 25/00

(52) U.S. Cl. CPC B65B 25/001; B32B 27/36; B32B 7/12; B32B 27/08; B65B 25/005; A23V 2002/00; B65D 65/40; A23G 3/54; A23L 25/25; B32B 2439/70; B65D 81/24

(57) ABSTRACT

The rancidity of prepackaged candied or sugared nuts, especially, sugar coated almonds, pecans and cashews, is inhibited by packaging the foodstuffs in a GRAS plastic material. This enables the nuts to be exposed to continuous heating or heating and cooling cycles such as within a conventional food warmer or exposure to heating lamps at temperatures up to about 200° F. for extended periods of up to about thirty (30) days while impeding the rancidity of the nut products. Suitable GRAS packaging materials include low-density polypropylene, low-density polyethylene, PET polyester laminates, and the like. The packaging can be in any geometric form. The sugar coated nuts are prepared by coating the nuts with a natural sweetener which may be sugar, corn syrup or like natural sweeteners.

### CROSS REFERENCE TO RELATED APPLICATIONS

This application is a continuation-in-part of co-pending U.S. patent application Ser. No. 16/778,411, filed Jan. 31, 2020, which, in turn, is a completion application based on U.S. Provisional Patent Application Nos. 62/920,592, filed May 7, 2019 and 62/851,283 filed May 22, 2019, each for “Food Package and Method of Manufacturing Same”, the disclosures of which are hereby incorporated by reference, including the drawings.

### BACKGROUND OF THE INVENTION

### 1. Field of the Invention

The present invention concerns food packaging. More particularly, the present invention concerns heat retaining food packaging. More particularly, the present invention concerns methods of packaging foodstuffs with heat retaining food packaging.

### 2. Prior Art

As disclosed in the above referred to co-pending and provisional patent applications there is described therein the packaging which can keep the packaged food, i.e., nut products, in a warm environment for an extended period of time without degradation of the packaging, itself, as well as preventing a plastic taste being imparted to the packaged food and without the food, itself, becoming rancid.

It has now been found, as described hereinafter, a method for further enhancing the storage stability and taste of the food contained within the plastic material.

As is known to those skilled in the art to which the present invention pertains, foodstuffs in today's marketplace are often packaged in recyclable materials such as GRAS (Generally Regarded As Safe) synthetic biodegradable plastics, as well as paper, etc., and which are maintained at ambient conditions. Ordinarily still, the packaging material maintains the quality of the packaged food for only a short period of time or, if in a typical plastic, e.g., cellophane, imparts a plastic taste to the foodstuff for a short period of time. This leaves the retailer, user or consumer with few choices for maintaining a warm product for any extended period of time without degrading the packaging material, as well as the foodstuff, therewithin.

While there exist certain plastic materials which can be heated for short periods of time, typically they cannot be sustained at an elevated temperature for extended periods of time without tainting a food product packaged therewithin.

Thus, it is clear that there is a need for a packaging which can keep the packaged food, i.e., nut products and, in particular, sugar coated nuts, including almonds, pecans and cashews, as well as salted nuts in a warm environment for an extended period of time without any degrading of the packaging, itself, as well as preventing a plastic taste to the coated nuts in the package and without the nuts, themselves, becoming rancid. It is this to which the present invention is directed.

### SUMMARY OF THE INVENTION

In accordance with the present invention, it has been found that candy coated, e.g., sugar coated nuts and, in particular, almonds, pecans and cashews, can have an extended shelf life when packaged within certain plastics which can be heated, cooled and re-heated multiple times or maintained in an oven, under heat lamps and the like at an elevated temperature of upwards of from about 120° F. to about 190° F. for an extended period without rendering nut products packaged therewithin rancid.

For a more complete understanding of the present invention reference is made to the following detailed description and accompanying drawing. In drawing like reference characters refer to like parts throughout the several views in which:

### BRIEF DESCRIPTION OF THE DRAWING

FIG. 1 is an exploded, perspective view of a packaging for use in the practice of the present invention;

FIG. 2 is a plan view of an assembled package for use in the present invention;

FIG. 3 is a cross-sectional view of the packaging taken along line 2-2 of FIG. 1;

FIG. 4 is a perspective view of a final packaging containing a foodstuff therewithin; and

FIG. 5 is a cross-sectional view of an alternate embodiment of the present invention.

### DESCRIPTION OF THE INVENTION

As disclosed in the above referred to co-pending application it has been found that certain plastics, i.e., polymeric materials, can be heated, cooled and reheated multiple times or maintained at an elevated temperature without rendering nut products packaged therewithin rancid over a period of time.

Now, it has been found that candy coated and, in particular, sugar coated nuts are particularly amenable to be packaged in the specific heat retaining materials in a warming oven, under heat lamps and similar warming appliances which thereby enable the nuts to be heated, cooled and re-heated multiple times or maintained at elevated temperatures without the sugar-coated nuts becoming rancid over an extended period of time.

Sugar coated almonds, pecans and cashews are particularly amenable to the present invention.

The heat retaining polymeric material from which the packaging is made, preferably, comprises a GRAS rated low-density polypropylene polymeric film material. Such polymeric film is well known and commercially available such as that available from A-ROO and are defined as heat retaining polypropylenes. This polypropylene material contemplated for use herein is capable of being repeatedly heated up to a temperature of less than about 200° F. in a warming oven and can, also, be placed under a heating lamp or similar warming/heating appliance without melting or tainting the taste of the contents, i.e., nuts or nut products, as well as preventing any nuts packaged therewithin from becoming rancid over an extended period of time while going through repetitive heating cycles. Likewise, these materials can be maintained at an elevated temperature of about less than 200° F. over an extended period of time, e.g., up to about thirty (30) days while impeding any rancidity of the nut products packaged therewithin.

Other useful GRAS materials which can be used herein are heat retaining GRAS polymeric polyethylene films and, in particular, low-density polyethylenes as disclosed in Publication No. WO2017/070925A1 for “Infrared Absorbing Heat Retaining Film”.

Another useful GRAS film is a laminate formed from a PET (polyethylene terephthalate) polyester film, where there is a first PET layer, a suitable intermediate layer adhesive and a second heat sealable GRAS PET film layer.

These film laminates are well known and commercially available such as that sold by Poly Print of Tucson, Ariz.

Typically, these PET polyester films have low water vapor transmission (WVPT) of about 1.0 grams per 100 square inches over 24 hours at 90° relative humidity as measured according to ASTM F 1249 and an oxygen transmission rate (OTR) according to ASTM D 3985 of about 1.527 as measured in cc's per hundred square inches over 24 hours at 0% relative humidity.

In use, preferably, the first layer of the laminate has a seal strength of greater than 350 grams per inch. The sealable film has a seal strength of about 40 to about 50 grams per inch as measured by ASTM F 88.

As with the polypropylene films, these other films can be placed through heat cycles of warming and cooling within a warming environment such as a conventional warming oven without tainting the product and inhibiting or impeding any rancidity of the nuts for up to about thirty (30) days or longer while the package and content go through the various heating and cooling cycles.

The criticality attached to these films is not only their ability to not taint the foodstuff packaged therewithin while going through repeated warming and cooling cycles, but, also, that they are usable in connection with the nut products such that they are considered GRAS (Generally Regarded As Safe).

Optional alternative GRAS materials include HDPE films, polyurethane films, combined low-density or high-density polyethylene films and the like.

These heat exposure materials contemplated for use herein can keep a nut product contained within its package warm for an extended period of time of up to about thirty (30) days or longer in a warming oven without ruining the nut product by imparting a deleterious taste to the foodstuff. Furthermore, the utilization of the plastic material for the packaging with respect to nuts, enables the quality of the nuts to be maintained by precluding the nuts from becoming rancid when maintained in warmers or in a warming unit over the defined period of time. This is especially true since rancidity does not occur even when the packaged nuts are exposed to on and off heat cycles, as compared to products which are unpackaged or in paper packaging, or in other plastics, i.e., cellophane. Inhibiting or impeding the rancidity is effective whether or not the warming system is a traditional heating oven- or a heating lamp.

It is to be understood that although the present invention has particular efficacy with sugar coated nuts, it is applicable to salted nuts.

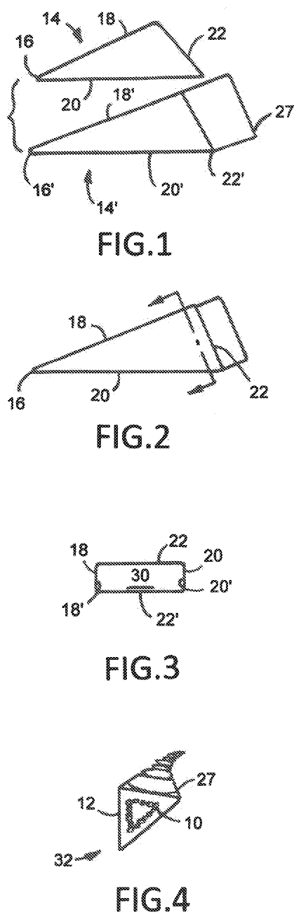

Now, and with reference to the drawing, and, in particular, FIGS. 1-4, there is depicted therein a first embodiment of a packaged foodstuff, e.g., a quantity of nuts, generally, denoted at 10 which is contained within a heat retaining packaging material 12.

As shown in the drawing, the packaging material or packaging of the type contemplated for use herein, generally, comprises a substantially triangular upper body 14 having an apex 16 with lateral sides 18, 20 and a base or bottom edge 22. The packaging further comprises a coincident lower triangular body 14′ having an apex 16′, lateral sides 18′ and 20′ as well as a base or bottom edge 22′. The bottom triangular body has an elongated flap 27 which can be used for effectuating a sealing and presenting an attractive appearance for the package, as described hereinbelow.

It is to be understood that although the present invention is described with respect to a triangular package, other geometric configurations, such as rectangles or squares can be used. In all such instances, the lower sheet would be larger than the upper sheet in order to be able to create a sealing flap overlying the top sheet.

In practicing the present invention and as shown in FIGS. 3 and 4, the layers of packaging material may be formed into, essentially, a conical package 32.

The two layers are sealed along the length of the sides such as by heat-sealing or the like to form an open-topped package 32.

The layers are, then, separated to provide access to the interior 30 defined therebetween.

The foodstuff 10, which, as noted, is preferably a quantity of nuts, such as salted or unsalted peanuts, sugar coated almonds, pecans or cashews and other types of nuts can then be inserted through the opening into the interior 30 and maintained therewithin.

Thereafter, the bottom edges 22, 22′ are sealed; the flap 27 twisted, and a non-metallic clip or the like (not shown) is used for decorative purposes by wrapping it around the twisted flap.

Thus, once the foodstuff is placed within the package and sealed it can then be heated, cooled and reheated for an extended desired period of time at a temperature below about 200° F. for up to about thirty (30) days or longer without having any spoilage due to the film imparting a deleterious taste or odor to the foodstuff, or the nuts becoming rancid.

These films can be used in a form and fill packaging whereby the bag may be filled with nuts including peanuts, almonds, cashews, etc.

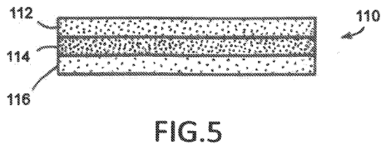

Now with reference to FIG. 5 there is depicted therein an alternate embodiment hereof using a laminated PET film. A laminated film, generally, denoted at 110 comprises a first layer of a PET (polyethylene terephthalate) polyester film 112. A suitable intermediate layer adhesive 114 and a second heat sealable PET film layer 116 disposed thereabove.

The adhesive layer 114 adheres the films together. A suitable adhesive is, for example, a well-known polyurethane adhesive typically sold under the trademark Polythene may be used.

The two sheets of film are adhered together with the adhesive under suitable heat-sealing conditions well known to the skilled artisan.

It is to be understood that it is not the formation of the film which forms part of the instant invention but its utilization in packaging the foodstuffs (nuts) contemplated for use herein.

It is to be further understood that although the present invention has been described with reference to polypropylene, polyethylene and PET films, it is within the ambit of the present invention to apply any polymeric film that can be placed within a heated environment and maintained thereat, or put through warming and cooling cycles without imparting a deleterious taste or otherwise tainting the foodstuff packaged within the parameters set forth above, i.e., being reheated multiple times and for extended periods of time.

It should be noted that the exterior sides of the layers may be printed with indicia such as a brand name, product identification or like indicia placed thereon.

As noted above, it has been observed that so-packaged foodstuffs can have a shelf life in a warming oven or under a heat lamp of up to about thirty (30) days, or longer.

It is apparent from the preceding that there has been described herein a method of warming and maintaining in a warm or heated state, various types of nuts for an extended period of time as well as a package therefor. This enables a retailer to sell warm nut products to the consumer.

Although any type of nut can be used herein, preferably, as noted, sugar coated pecans, almonds and cashews are rendered most amenable to the present process.

Having, thus, described the invention, what is claimed is:

1. In a method for inhibiting pre-packaged nut products from rancidity when exposed to heat for an extended period of time, the improvement of which comprises:
(a) packaging a nut product within a GRAS polymeric film package, the film being selected from the group consisting of (i) a low-density polypropylene polymeric film, (ii) a low-density polyethylene film and (iii) a polyethylene terephthalate polyester laminate film, and (b) sealing the film package with a nut product contained therewithin.

2. The method of claim 1 wherein the GRAS film is a low-density polypropylene film.

3. The method of claim 1 wherein the GRAS film is a low-density polyethylene film.

4. The method of claim 1 wherein the GRAS film is a polyethylene terephthalate polyester film.

5. A method for packaging a nut product, comprising:
a) providing a GRAS polymeric film pouch;
b) placing a quantity of a nut product within the pouch;
c) sealing the pouch,
wherein the film is selected from the group consisting of (1) a low-density polypropylene film, (2) a low-density polyethylene film and (3) a polyethylene terephthalate polyester film laminate and
further, wherein the pouch can be heated, cooled and reheated or maintained in a warm state for extended periods of time and cycles while impeding the nut product from becoming rancid.

6. The method of claim 5 wherein the nut product can be heated and cooled within the pouch within a conventional warming oven or heating lamp for up to about thirty days.

7. The method of claim 6 wherein the GRAS polymeric film is a low-density polypropylene.

8. The method of claim 6 wherein the GRAS polymeric film is a low-density polyethylene.

9. The method of claim 6 wherein the GRAS film is a polyethylene terephthalate polyester film laminate.

10. The method of claim 5 wherein the nut product is a candy coated nut product.

11. The method of claim 9 wherein the candy coated nut product is selected from the group consisting of almonds, pecans and cashews.

12. The method of claim 1 wherein the nut product is a candy coated nut product.

13. The method of claim 12 wherein the nut product is selected from the group consisting of sugar-coated almonds, pecans and cashews.

14. The method of claim 1 wherein the nut product is a salted nut product.

15. The method of claim 5 wherein the nut product is a salted nut product.
